(19) United States
(12) Patent Application Publication
(10) Pub. No.: US 2016/0027098 A1
(43) Pub. Date: Jan. 28, 2016

(54) INTERACTIVE DOOR DISPLAY DEVICE AND METHOD

(71) Applicant: Masonite Corpoation, Tampa, FL (US)

(72) Inventor: Jack THORNTON, Plant City, FL (US)

(21) Appl. No.: 14/610,179

(22) Filed: Jan. 30, 2015

Related U.S. Application Data
(60) Provisional application No. 62/027,445, filed on Jul. 22, 2014.

(51) Int. Cl. G06Q 30/06; G06T 11/60

(52) U.S. Cl. CPC G06Q 30/0643; G06T 11/60

(57) ABSTRACT

A display device featuring a door frame and a first door skin having an opening is provided. The first door skin can be coupled to a first face of the door frame. The display device can further include a display screen provided within the opening of the first door skin and a controller node coupled to the display screen. The controller node can be configured to receive an indication of a first input detected at the display screen, retrieve a plurality of door characteristics based on the indication of the first input detected at the display screen, generate an image to display on the display screen based on the plurality of door characteristics, receive an indication of a second input associated with a selection of one of the plurality of door characteristics, and generate an image associated with the selection of one of the plurality of door characteristic.

This application claims priority to provisional application Ser. No. 62/027,445, filed on Jul. 22, 2014, the disclosure of which is incorporated herein by reference and to which priority is claimed.

### FIELD OF THE INVENTION

The present invention is directed to a display device and method of using the display, and, more particularly, to an interactive door display device and method of operation allowing selection of a door configuration by a user and arranging for associated purchase, manufacturing and shipment of the user-defined door system.

### BACKGROUND

Doors, especially entry doors for residential and commercial properties, are often provided with a partial or full window-like glazing panel sometimes known as a lite. These panels can be made of, for example, insulated glass or plastics, such as polycarbonate. In addition, these panels can have various shapes and configurations where the panel is installed within a frame for a door that can include, for example, molded panels or door skins Similarly, the door may be associated with a side lite adjacent the door and/or a transom lite above the door. The selection and configuration of the door lite, side lite and transom lite are important steps in creating a door entry system in which all the components are selected by the consumer to achieve a desired appearance.

Typically, a user selects a custom door configuration including a glazing panel from a printed catalog at a dealer. Each door configuration is generally unique to the user. It is undesirable and expensive for a dealer to store and display various door configurations within a showroom. Without a visual example, it makes it difficult for a user to appreciate the appearance of a selected door configuration where the unique selection is made using only the printed catalog, particularly when the user may also want a side lite and/or a transom lite. Once a selection is made, the user cannot visualize the selected configuration, particularly as installed in the user's home, until after the door is manufactured, delivered and installed.

Therefore, a need exists for an interactive door display device that allows a user to select and view a door configuration before purchasing a custom door.

### SUMMARY OF THE INVENTION

An aspect of the invention provides a display device featuring a door frame and a first door skin having an opening. The first door skin can be coupled to a first face of the door frame. The display device can further include a display screen provided within the opening of the first door skin and a controller node coupled to the display screen. The controller node can be configured to receive an indication of a first input detected at the display screen, retrieve a plurality of door characteristics based on the indication of the first input detected at the display screen, generate an image to display on the display screen based on the plurality of door characteristics, receive an indication of a second input associated with a selection of one of the plurality of door characteristics, and generate an image associated with the selection of one of the plurality of door characteristic. This process continues until the consumer/user has selected an entry system that has the features and appearance that the user/consumer desires. Because the display displays all of the selected features and characteristics, the user/consumer may better appreciate the appearance of the entry system that will be manufactured and ultimately installed.

Other aspects of the invention, including apparatus, articles, methods, systems, assemblies, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is an elevational view of a door display according to an exemplary embodiment of the invention.

FIG. 2 is an exploded assembly drawing of the door display of FIG. 1.

FIG. 3 illustrates an exemplary method of displaying door characteristics according to an exemplary embodiment of the invention.

FIG. 4 is a diagram of a system according to an exemplary embodiment of the invention.

FIGS. 5-10 illustrate a view of the door display during selection of the door characteristics according to an exemplary embodiment of the invention.

### DETAILED DESCRIPTION OF THE EXEMPLARY EMBODIMENTS AND EXEMPLARY METHODS

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “top” and “bottom” as well as derivatives thereof (e.g., “horizontally,” “downwardly,” ^{“}upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the word “a” as used in the claims means “at least one”.

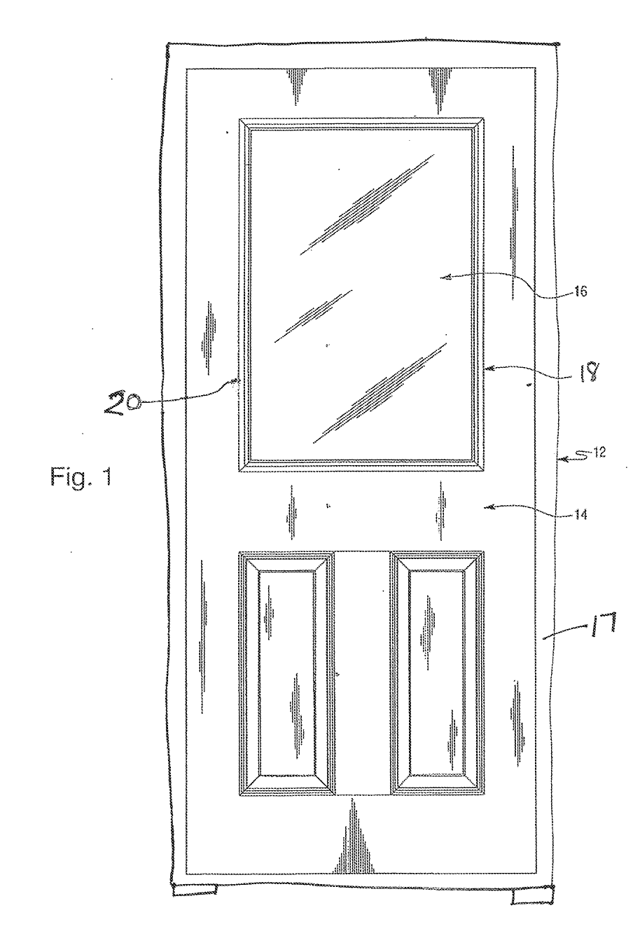

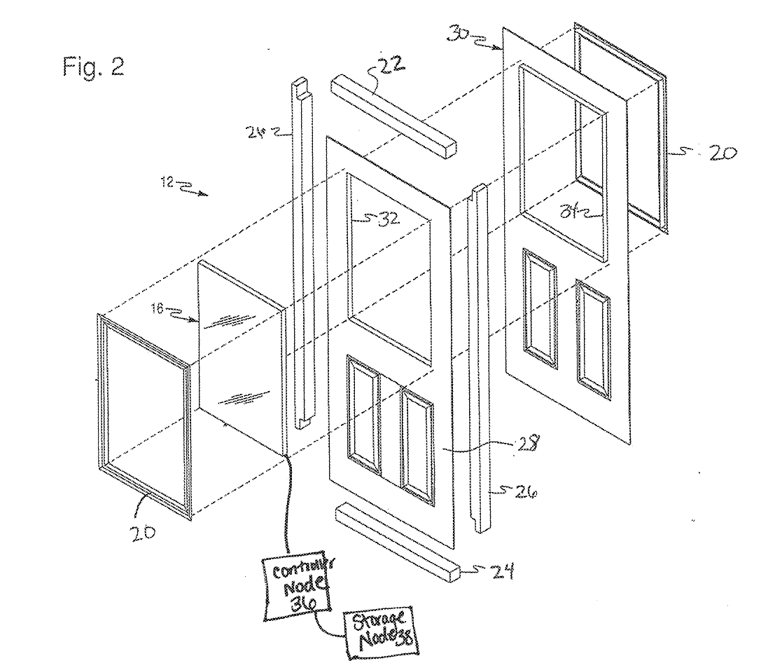

FIGS. 1 and 2 illustrate an interactive door display 12 according to an exemplary embodiment of the present invention. Door display 12 includes a door body 14, a display screen 16, and a support structure 17. Door body 14 can be mounted within the support structure 17. An opening 18 is provided in door body 14 where the display screen 16 is provided within the opening. In an exemplary embodiment, a frame 20 can extend around the periphery of the display screen 16. The frame 20 may be a frame such as used to mount a door lite to a door skin, such as a door skin of the type used with door body 14. The door display 12 can be representative of a residential or commercial door design such as an exterior door. Door display 12 can be a free standing device such that door display 12 does not need to be installed in a wall or other permanent structure. Support structure 17 allows the door display 12 to be supported and moveable and/or portable to a desired location. In an exemplary embodiment, support structure 17 can surround the door body 14, thereby securing the door body 14 in a vertical position.

As best illustrated in FIG. 2, the door body 14 includes a top rail 22, a bottom rail 24, side stiles 26, a first door skin or facing 28, and optionally a second door skin or facing 30. Rails 22, 24 and stiles 26 define a rectangular frame having opposite first and second faces. The first door skin 28 is coupled to the first face of the frame and the second door skin 30 is coupled to the second face of the frame. In an exemplary embodiment, adhesive can be used to secure the first and second door skins 28, 30 to the frame. Alternatively, mechanical fasteners, or the like, may be used. After the first and second door skins 28, 30 are coupled to the frame, a cavity is formed between the skins 28, 30. While two door skins 28, 30 are illustrated in FIG. 2, one of ordinary skill in the art would recognize that only one door skin, for example, door skin 28, can be coupled to a face of the frame.

The first and second door skins 28, 30 may be formed from an appropriate material and have a thickness of, for example, about 1 mm to about 4 mm. The selected material of the door skins 28, 30 can be sheet molding compound (SMC) with reinforcement (e.g., fiber glass, cellulosic material, etc.), metal (e.g., steel), wood, medium density fiberboard, high density fiberboard, or other materials suitable for the contemplated use. The door skins 28, 30 may be made of the same or different materials. The door skins 28, 30 may be molded from such materials as fiberglass reinforced plastics, pressed board, thermosetting compounds (e.g., vinyl esters), thermoplastics (e.g., polypropylene, polystyrenes), cellulosic material and resin composites, or other moldable materials. The outer surfaces of the door skins 28, 30 can be smooth or can have a simulated wood grain. The depth of the wood grain optionally is about 0.05 mm to about 0.2 mm. An inner surface of the door skins 28, 30 may have a relatively rough or textured surface to increase the surface area for adhesion to the door frame. The roughened inner surface may provide stronger bonds between the door skins 28, 30, the rails 22, 24, and the stiles 26.

A first opening 32 is provided in the first door skin 28 and a second opening 34 is provided in the second door skin 30. After the first and second door skins 28, 30 are coupled to the frame, openings 32 and 34 can be aligned such that at least a portion of the display screen 16 is mounted within the openings 32, 34. Again, it is noted, if only one door skin 28 is used, the display screen 16 would be mounted within opening 32. While openings 32, 34 are shown having a rectangular shape, they can have any shape such as oval, circular, square, triangular, semi-elliptical, etc. In an exemplary embodiment, the shape of the openings 32, 34 can directly correlate to the shape of the display screen 16. Alternatively, the openings 32, 34 can have a shape different from the shape of the display screen 16. For example, when the openings 32, 34 have an oval or semi-elliptical shape and the display 16 has a rectangular shape, a portion of the first and second door skins 28, 30 can overlay the display 16.

Display screen 16 can be a display panel configured to display images, graphics, text, characters, etc. For example, display screen 16 can be a liquid crystal display (LCD), an organic light emitting display (OLED), a plasma display, an electroluminescent display, or the like. In an exemplary embodiment, display screen 16 can be a touch screen such that the display is configured to receive inputs using pressure or heat associated with a user's finger or other input device such as a stylus. For instance, when a user contacts the surface of display screen 16 within an active area of the display, it can be determined that an input has been received from the user. While display screen 16 is shown as having the size and shape as illustrated in FIGS. 1 and 2, display screen 16 can have a different size and shape. For example, display screen 16 can have a shape having dimensions in the range of approximately 22 inches by 36 inches to approximately 22 inches by 64 inches. However, any size and shape of display screen 16 is contemplated such as oval, semi-elliptical, etc.

A controller node 36 is coupled to display screen 16. The controller node 36 is configured to receive an indication that an input has been received at the display screen 16 and to transmit information to be displayed on the display screen 16 based on the received input. The controller node 36 can be disposed within the door frame such as in the cavity formed between the first and second door skins 28, 30 and/or coupled to the door frame or at least one of the first and second door skins 28, 30. Alternatively, controller node 36 can be disposed outside of the door frame. In an exemplary embodiment, a ventilation device can be coupled to the controller node 36 to prevent overheating. Alternatively, an opening or openings associated with the controller node 36 can be disposed in at least one of the first or second door skins 28, 30 to allow heat associated with the controller node 36 and/or storage node 38 to dissipate in response to operation of the ventilation device, which may include a motor-driven fan.

Controller node 36 can include a processor and associated circuitry to execute or direct the execution of computer-readable instructions to obtain information. Controller node 36 can retrieve and execute software from storage, which can include a disk drive, a flash drive, memory circuitry, or some other memory device, and which can be local or remotely accessible. The software includes computer programs, firmware, or some other form of machine-readable instructions, and may include an operating system, utilities, drivers, network interfaces, applications, or some other type of software, including combinations thereof. Controller node 36 can receive instructions or other inputs at a user interface such as at display screen 16. Alternatively, controller node 36 can receive instructions or other inputs using peripherals such as a keyboard, mouse, etc. In addition, door display 12 can further include speakers to transmit audio messages.

In an exemplary embodiment, a storage node 38 is coupled to the controller node 36. The storage node 38 can be any node configured to store information such as information associated with interactive door display 12. The storage node 38 can be disposed within the door frame such as in the cavity formed between the first and second door skins 28, 30. Alternatively, storage node 38 can be disposed outside of the door frame. While storage node 38 is illustrated as being separate from controller node 36, storage node 38 can be integral with controller node 36.

In an exemplary embodiment, information associated with various door characteristics such as glass style, door style, glass and door material, door texture, glass and/or door size, glass shape, glass and door color, glass opacity, door fire rating, door energy rating, and the like can be stored in storage node 38 such that the information associated with at least one door characteristic can be retrieved by the controller node 36 and displayed on the display screen 16. In addition, videos can also be stored at the storage node 38. For example, the videos stored at storage node 38 can include information associated with various door characteristics and configurations, installation information, and/or educational material. For instance, a video having installation information can provide instructions on how to install a door, remove a door, take door measurements, etc. A video including educational material can be associated with the location in which the door display 12 is located. For example, when the door display 12 is located at a door dealer, the educational material can be tailored specifically to the information the door dealer needs to know and learn.

In operation, a default image can be displayed on the display screen 16 of an interactive door display 12. For example, the default image can be one or more screen savers including a single image or a plurality of images where each image is displayed for a predetermined time period and then rotated through a cycle. Alternatively, the default image can be a launching page where the image includes an initialization indication to the user. In an exemplary embodiment, the launching page can include various icons including at least one of a door customization menu icon, a glass opacity privacy icon, email icon, etc.

When the user interacts with the initialization indication, such as by pressing a portion of the display screen 16 associated with the initialization indication with a finger, the user can be presented with a plurality of door customization options. For example, glass (lite) style, door style, glass and/or door material, door texture, glass and/or door size, and shape, glass and door color, glass opacity, door fire rating, door energy rating, and the like are available options. In an exemplary embodiment, the door customization options are displayed on the display screen 16 where an array of small or “thumbnail” images are presented to a user, where the array of images correspond to door characteristics of the same type. However, one of ordinary skill in the art would recognize that the door customization options can be displayed in any format such as list, pull down menu, etc.

In an exemplary embodiment, when an indication is received at the display screen 16 associated with a selection of glass style, various glass (lite) styles are presented to the user on the display screen 16. The various glass styles can include at least one of different bevel configurations and arrangements, different art glass shapes, sizes, materials, etc., different caming features, various pane configurations, different grid arrangements and configurations, etc. The glass styles can further include a lite, a side lite, and/or transom configurations because frequently exterior doors are sold not only with a lite but also as a pre-hung door assembly or entry system including additionally a side lite and/or a transom lite. The user can select one of the glass styles from the plurality of glass styles presented on the display screen 16 by interacting with the portion of the display screen 16 associated with the corresponding image of the desired glass style. The selected glass style is then presented on the display screen 16 where the size of the image is approximately to scale and directly associated with the size and shape of a glass panel available for purchase in the customized door configuration. Moreover, should the user select a side lite and/or a transom lite, the display screen 16 can display the side lite, transom lite and door with lite so that the user can better visualize the door system prior to ordering and purchase.

In another exemplary embodiment, when an indication is received at the display screen 16 associated with a selection of door style, various door styles are presented to the user on the display screen 16. The various door styles can include different number and size of panels, different panel arrangements, different panel configurations, and different door installment locations such as entry way, interior, patio, etc. For example, the various door styles can include any number of panels within a single door such as 1 panel, 2 panels, 3 panels, 6 panels, etc. The panels can be symmetrically or asymmetrically arranged. The panels can be configured to have a smooth or textured surface. The user can select one of the door styles from the plurality of door styles presented on the display screen 16 by interacting with the portion of the display screen 16 associated with the corresponding image of the desired door style. The selected door style is then presented on the display screen 16 where the size of the image is approximately to scale and directly associated with the size, shape, arrangement, and configuration of a door style available for purchase in the customized door configuration.

In another exemplary embodiment, when an indication is received at the display screen 16 associated with the texture and/or material of a door, various textures and/or materials can be presented to the user on the display screen 16. The various textures such as simulated wood grains including oak, cherry, walnut, mahogany, cedar, fir, etc. The various materials can include fiberglass, steel, wood, etc. In addition, the various textures can be combined with the various materials. For example, an oak wood grain could be available in a fiberglass or steel material. The user can select one of the various textures and/or materials from the plurality of textures and/or materials presented on the display screen 16 by interacting with the portion of the display screen 16 associated with the corresponding image of the desired texture and/or material. The selected texture and/or material are then incorporated into the image presented on the display screen 16 where the texture and/or material can be applied to a previously selected door style.

In another exemplary embodiment, when an indication is received at the display screen 16 associated with a glass opacity, a range of glass opacity options are presented to the user on the display screen 16. For example, potential glass opacity levels can range from 1 to 9 where an opacity level of 1 is substantially translucent allowing the most amount of light to pass through the glass and level 9 is obfuscated to allow the least amount of light to pass through the glass. When a plurality of glass panes is available, the user can individually identify the opacity of each glass pane where the user can select each pane and an indication of glass opacity can be presented for the selected pane. In addition to levels, glass opacity can be created using various textures where glass opacity texture options can be presented to the user on the display screen 16. Glass opacity textures can be selected from frosted glass, or be dependent upon the individual bevel characteristics, and/or color of individual bevels, etc. Those skilled in the art will understand that lites are frequently formed from a plurality of individual bevels, frequently each with its own size, shape and possibly coloring, with the bevels held together by caming and mounted within a peripheral frame, such as the frame 20 of FIG. 1. The typical lite has a graphically configured or styled panel formed from a plurality of bevels, with the panel being disposed between opposed glass or plastic panels that protect the stylized panel. The stylized panel frequently is of an image, with the other panels being clear to allow the stylized panel to be viewed.

The image displayed on the display screen 16 of the display device 12 based on the door characteristics can be generated after each door characteristic is selected. Alternatively, the image to be displayed on the display screen 16 of the display device 12 can be generated after two or more door characteristics have been selected or after all door characteristics have been selected. For example, a user can select one of each of a glass style, a door style, glass material, a door material, a door texture, a glass size, a door size, a glass shape, a door color, and a glass opacity level. An image incorporating all of the selected characteristics is generated and then displayed on the display screen 16 of the display device 12. In an exemplary embodiment, the resulting image is displayed to illustrate a potential door configuration that a user can purchase where the image allows the user to visualize the final door configuration prior to manufacturing the final door configuration. The user may, for example, initially select the material from which the door is to be formed, then select the style of door, then select the style of lite, and finally select the opacity of the lite. The display screen 16 can display each selection as it is chosen or can display the resulting door design after all selections have been made. The selection process preferably is iterative, with the user able to make selections, change selections and ultimately create an image of the door assembly that is desired.

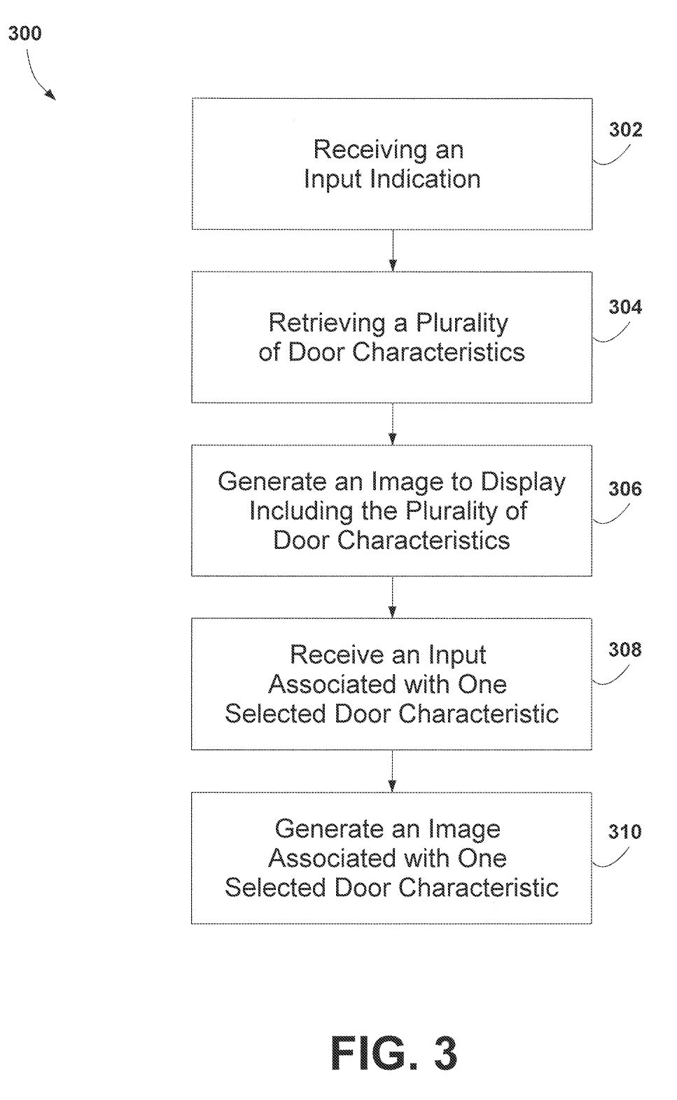

FIG. 3 illustrates a flow chart of an exemplary method of displaying door characteristics on a display device. The method 300 will be discussed with reference to the exemplary display device 12 illustrated in FIGS. 1 and 2. However, the method can be implemented with any suitable display device. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined, and/or adapted in various ways.

At 302, an input indication is received. For example, a user can interact with display device 16 using an input device such as a finger or stylus, generating the input indication associated with the interaction with the display device. The input indication can be received by controller node 36. In an exemplary embodiment, the input indication is associated with the user interacting with an initialization indication displayed on the display device 16.

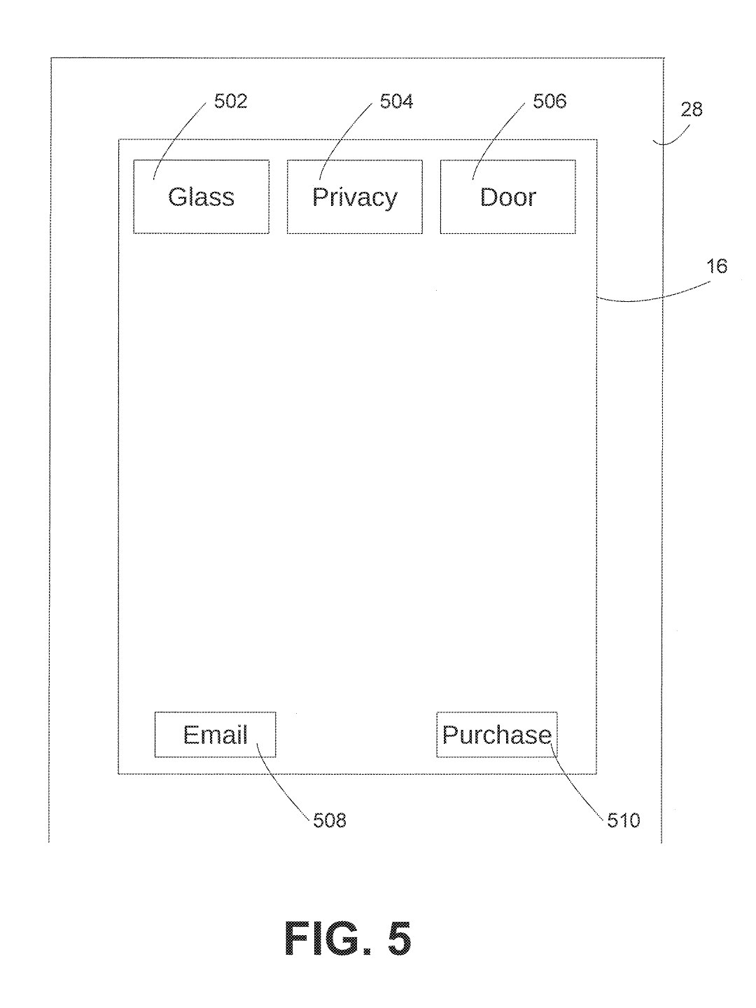

In an exemplary embodiment, as best illustrated in FIG. 5, an initialization indication such as a home screen is displayed on the display device 16 where the initialization indication illustrated in FIG. 5 includes various icons such as “glass” 502, “privacy” 504, “door” 506, “email” 508, and “purchase” 510. While various icons are illustrated in FIG. 5, one of ordinary skill in the art would recognize that any type of initialization indication can be displayed including information having alphanumeric characters, symbols, graphical icons, drop down menus, etc. In addition, a sleep mode or screen saver can also be displayed on the display device 16 before an input indication is detected at the display device 16.

A plurality of door characteristics is retrieved at 304. For example, controller node 36 can access at least one database where a plurality of door characteristics is stored in the at least one database associated with the input indication received. In an exemplary embodiment, the plurality of door characteristics can be stored at the controller node 36 and/or storage node 38. The plurality of door characteristics can include at least one of a glass style, a door style, glass and/or door material, door texture, glass and/or size, glass shape, glass and door color, glass opacity, door fire rating, door energy rating, and the like. The glass style characteristics can include at least one of different bevel configurations and arrangements, different art glass shapes, sizes, materials, etc., different caming features, various pane configurations, different grid arrangements and configurations, etc. The door style characteristics can include at least one of different number and size of panels, different panel arrangements, different panel configurations, and different door installment locations such as entry way, interior, exterior, patio, etc. Texture characteristics can include simulated wood grains including oak, cherry, walnut, mahogany, cedar, fir, etc. Material characteristics can be based on fiberglass, steel, wood, etc.

In an exemplary embodiment, when an input indication is received at the display device 16 in the area associated with the “glass” icon 502, the controller node 36 can access the database for a plurality of characteristics associated with the glass such as the glass style, size, shape, color, etc. When an input indication is received at the display device 16 in the area associated with the “privacy” icon 504, the controller node 36 can access the database for a plurality of characteristics associated with an opacity level for the glass. Likewise, when an input indication is received at the display device 16 in the area associated with the “door” icon 506, the controller node 36 can access the database for a plurality of characteristics associated with the door such as material, texture, color, etc.

At 306, an image is generated to be displayed on the display device that includes the plurality of door characteristics. For example, controller node 36 can generate the image including the plurality of door characteristics based on the retrieved door characteristics. The plurality of door characteristics can be compiled in various ways. For example, an array of small or “thumbnail” images can be generated, where the array of images correspond to door characteristics of the same type where one or more groups of door characteristics can be displayed on display device 16 at the same time. The controller node 36 can then instruct the display device 16 to display the generated image including the plurality of door characteristics.

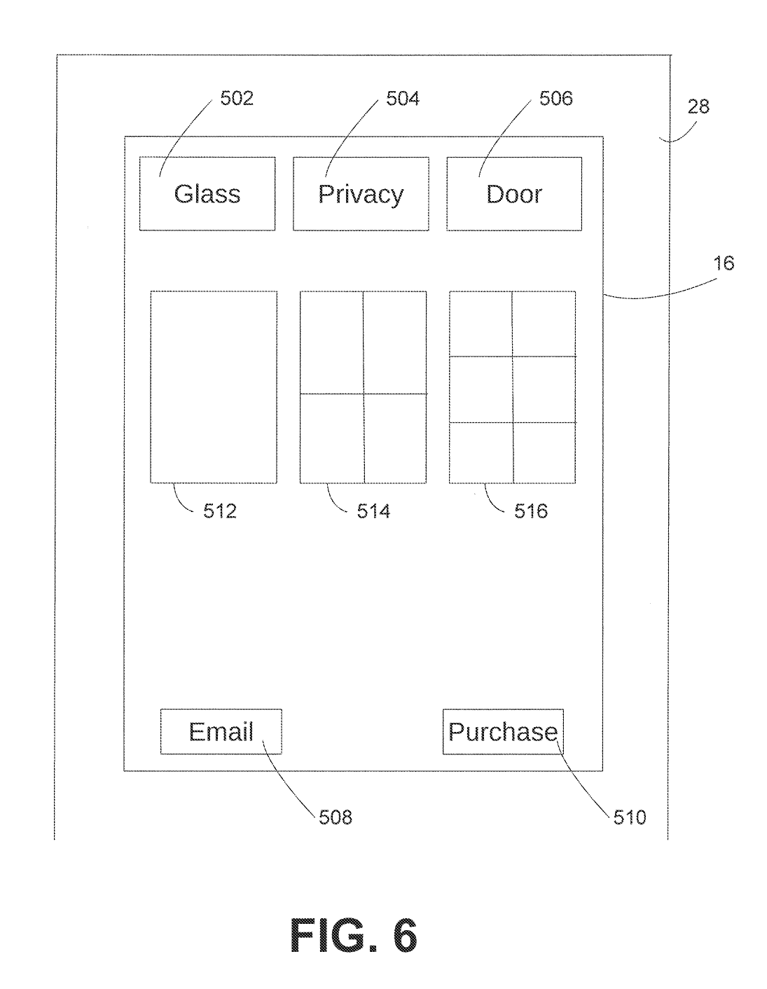

In an exemplary embodiment, as best illustrated in FIG. 6, after an input indication is received associated with the “glass” icon 502, a plurality of different types of glass style are displayed at the display device 16. For example, icon 512 illustrates a glass style where it is a single pane of glass, icon 514 illustrates a glass style having four panes of glass, and icon 516 illustrates a glass style having six panes of glass.

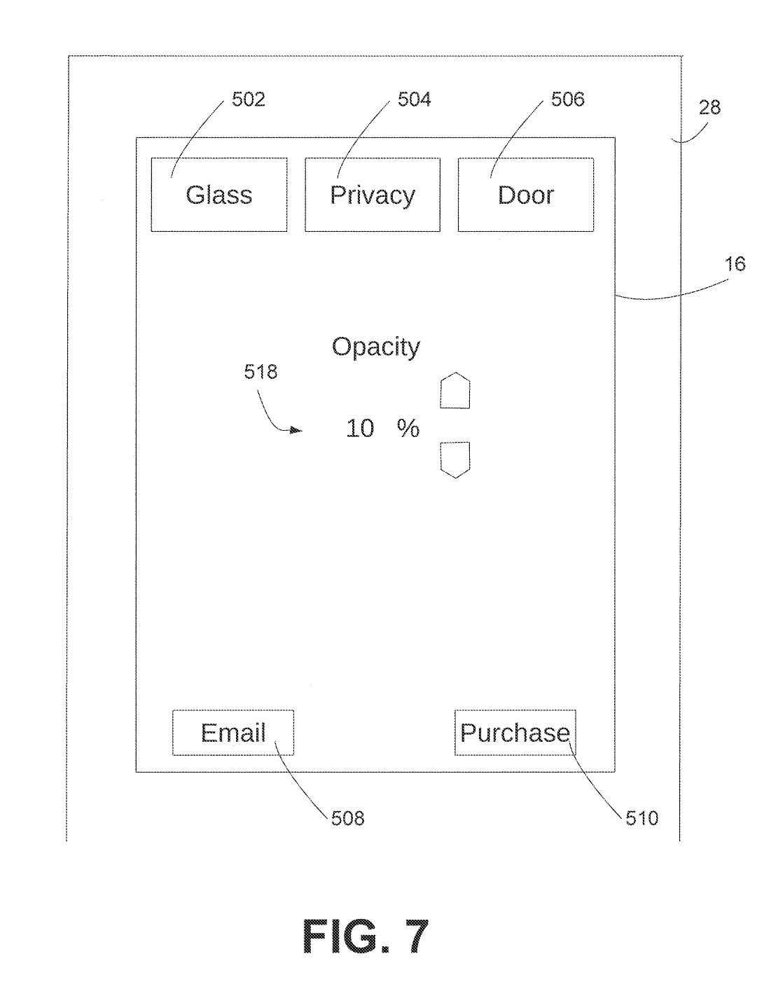

In another exemplary embodiment, as best illustrated in FIG. 7, after an input indication is received associated with the “privacy” icon 504, an interactive input icon 518 can be displayed at the display device 16 such that a user can identify a desired level of opacity associated with a selected glass style. The level of opacity can be increased or decreased using the up and down arrows. While the opacity level is illustrated as being an interactive input icon 518, the opacity can be presented to a user in various configurations such as a pull down menu, a level selection, etc.

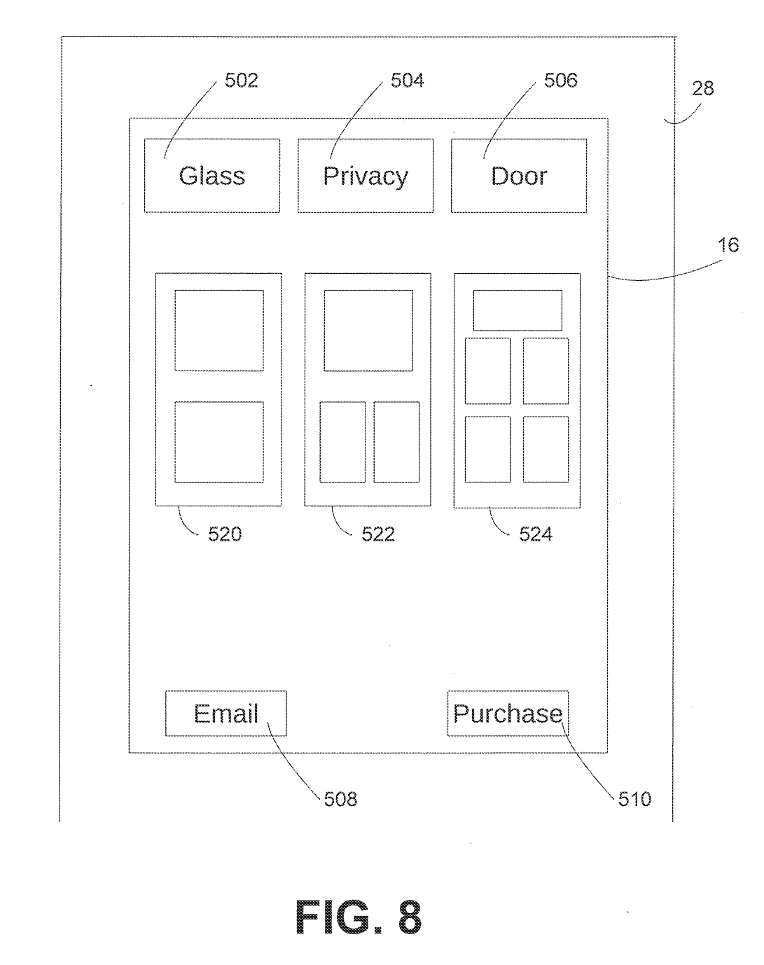

In another exemplary embodiment, as best illustrated in FIG. 8, after an input indication is received associated with the “door” icon 506, a plurality of different types of door configurations are displayed at the display device 16. For example, icon 520 illustrates a door having two panels, icon 522 illustrates a door having three panels, and icon 524 illustrates a door having five panels.

An input associated with one selected door characteristic is received at 308. For example, a user can interact with a portion of the display device 16 associated with a desired door characteristic. An indication associated with the selected door characteristic can be received at the controller node 36 from display device 16.

In an exemplary embodiment, a user can select one of the different types of glass styles illustrated in FIG. 6, where the input corresponds to the area of the display device 16 where the icon 512, 514, 516 is arranged, a level of opacity as illustrated in FIG. 7, and/or one of the different types of door configurations as illustrated in FIG. 8.

At 310, an image associated with the one selected door characteristic can be generated. For example, the controller node 36 can retrieve information associated with the one selected door characteristic and generate an image that is associated with the selected characteristic, such as an image having a size, shape, arrangement, configuration, texture, etc. that is approximately to scale. In other words, the size, shape, arrangement, configuration, and texture are illustrated such that the resulting image is approximately the same size, shape, arrangement, configuration, and texture found in an actual door configuration available for purchase from a dealer and/or distributer. In an exemplary embodiment, one or more door characteristics can be selected before the resulting image is generated such that the selected door characteristics can be combined within the generated image.

In an exemplary embodiment, the above steps can be performed numerous times. Once a user has determined the desired configuration using the display device, a door having the unique configuration can be selected. For example, the display device 12 can communicate the desired configuration to a dealer and/or a distributor such as via email or other electronic media. Payment can be performed using the display device 12 such that payment information can be input using the display screen 16. Alternatively, display device 12 can further be coupled to a printer where information associated with the desired configuration can be printed using the printer. In an alternative embodiment, pricing information, installment information, installment scheduling, can also be displayed and/or selected using the display device 12.

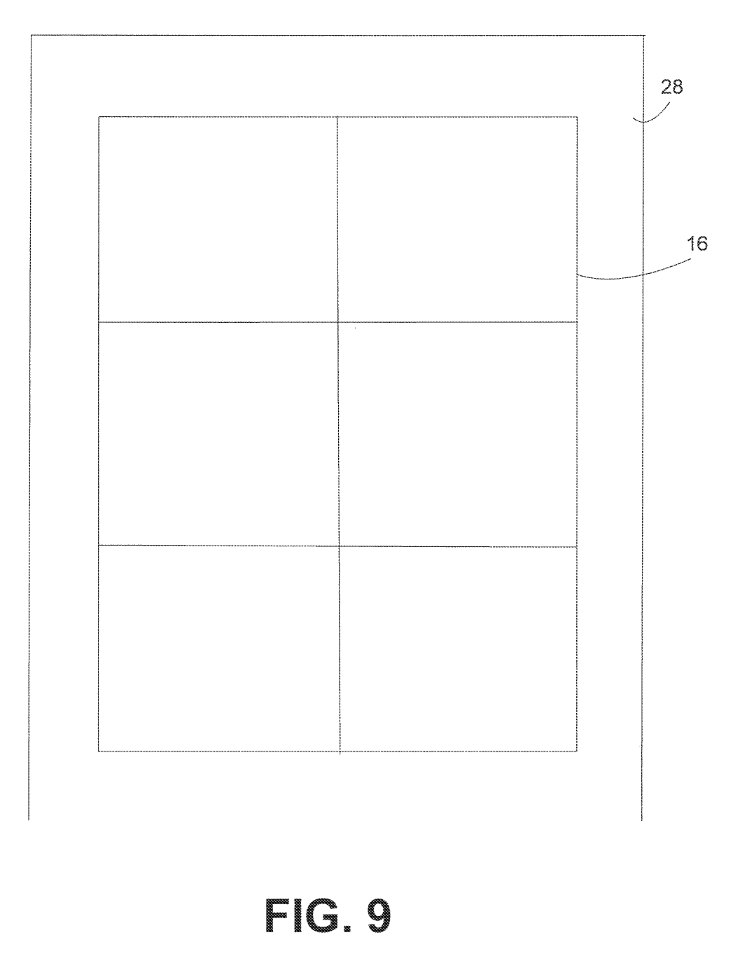

In an exemplary embodiment, as best illustrated in FIG. 9, when a glass style associated with icon 516 is selected and a door configuration associated with icon 520 or 522 is selected, the resulting image illustrated in FIG. 9 is displayed. For example, the display image shows the six pane glass style to scale within the display device 16.

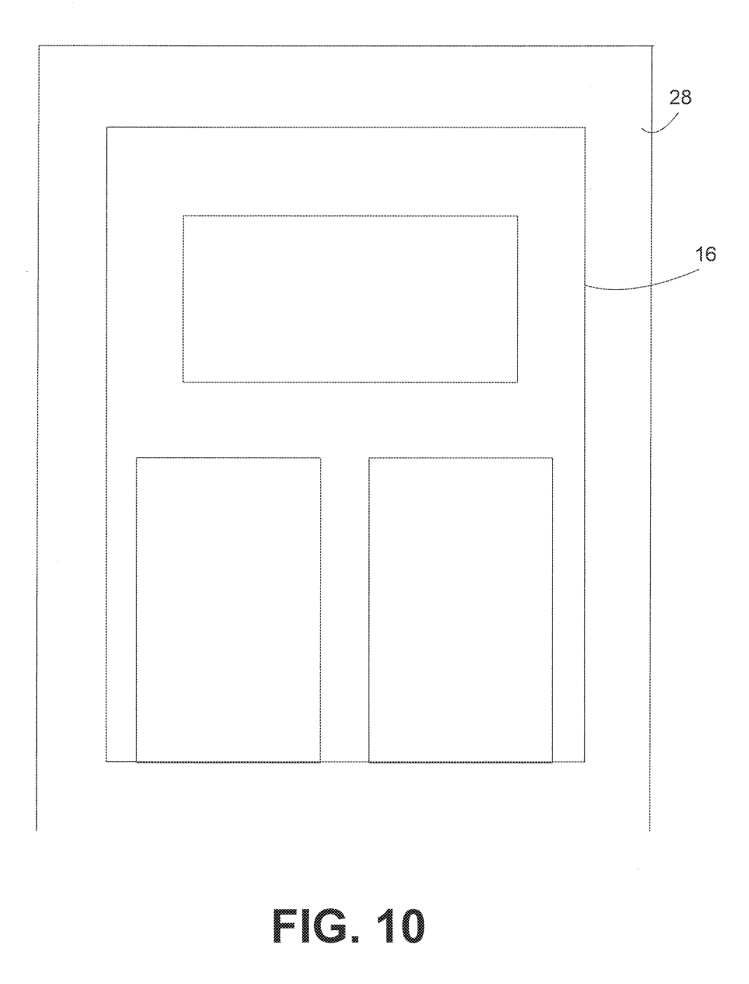

In another exemplary embodiment, as best illustrated in FIG. 10, when a glass style associated with icon 512 is selected and a door configuration associated with icon 524 is selected, the resulting image illustrated in FIG. 10 is displayed. For example, the size and shape of the glass is to scale and any selected door textures, material, color, etc. is further displayed on the display deice 16 such that the resulting image allows the entire display device 12 to appear to be a resulting door.

In another exemplary embodiment, a user can select various door characteristics to create a plurality of different door configurations where two or more of the configurations are displayed on the display 16 such as to allow a side-by-side comparison. In this embodiment, each door configuration including the door and the glass are presented on the display 16.

In another exemplary embodiment, the display device 12 can be configured to display a selected custom door configuration with an image of the intended installation location of the door in order to allow a user to better visualize how the selected custom door configuration will fit in with the environment of the intended location of the user. For example, a user can select various door characteristics to create a custom door configuration. An image of the location in which the custom door configuration is intended to be installed can be provided to the display device 12. The image can be provided by the user to the display device 12 in any known manner such as by uploading the image at the display device 12 or transmitting the image over a network in communication with the display device 12. The image of the intended installation location and/or the image of the custom door configuration can be manipulated by the user at the display 16. For example, the image of the intended installation location can be enlarged, reduced, cropped, etc. The image of the custom door configuration can then be aligned to the altered image of the intended installation location. In an exemplary embodiment, the user can directly interact with display 16 or interact with peripherals in communication with display device 12 to select and drag the image of the custom door configuration to the desired region of the image of the intended installation location. Alternatively, the image of the intended installation location can remain unchanged and the image of the custom door configuration can be manipulated (e.g., enlarged, reduced, etc.) and dragged to the appropriate location by the user.

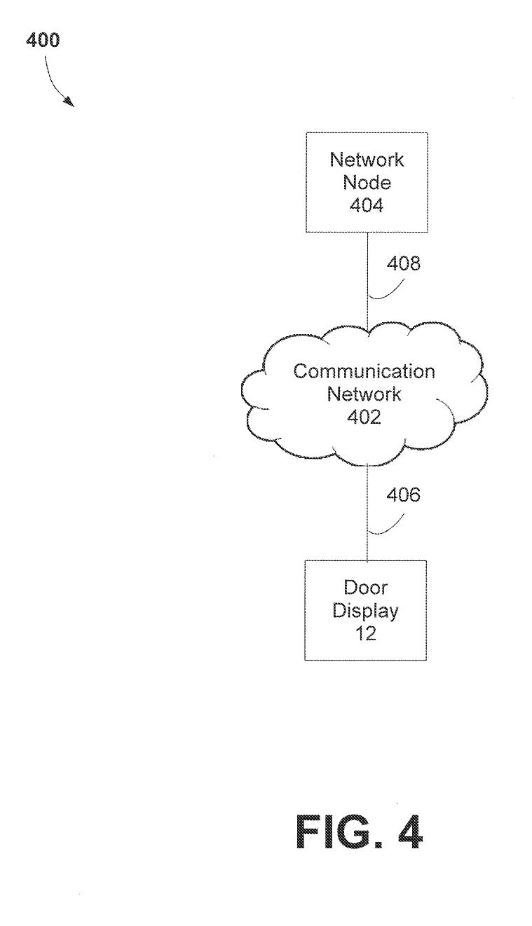

FIG. 4 illustrates an exemplary display system 400 for displaying door characteristics. Display system 400 includes display device 12, communication network 402, and network node 404. Other network elements can be provided within system 400 to facilitate communication, such as between display device 12 and communication network 404, which are omitted for clarity, including additional processing nodes, routers, gateways, and physical and/or wireless data links for carrying data among the various network elements.

Display device 12 further includes a communication interface (not illustrated) having one or more transceivers for transmitting and receiving data over system 400. For example, the communication interface can be a wired or wireless communication interface configured to allow display device 12 to communicate with communication network 402. The communication interface can be associated with one or more of the following networking protocols: transmission control protocol/internet protocol (TCP/IP), code division multiple access (CDMA), global system for mobile communications (GSM), worldwide interoperability for microwave access (WiMAX), long-term evolution (LTE), and/or high-speed downlink packet access (HSDPA), IEEE 802.11, wireless fidelity (WiFi), Bluetooth, Zigbee, infrared data association (IrDA), etc.

Communication network 402 can be a wired and/or wireless communication network, and can comprise processing nodes, routers, gateways, and physical and/or wireless data links for carrying data among various network elements, including combinations thereof, and can include a local area network, a wide area network, and an internetwork (including the Internet). Communication network 402 can be capable of carrying data, for example, to support data communications to and from display device 12. Wired network protocols that may be utilized by communication network 402 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Wireless network protocols can comprise code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX). Communication network 402 can also comprise additional base stations, controller nodes, telephony switches, internet routers, network gateways, computer systems, communication links, or some other type of communication equipment, and combinations thereof.

Network node 404 is any network node configured to transmit to and/or receive information from door display 12. Network node 404 can comprise a processor and associated circuitry to execute or direct the execution of computer-readable instructions to obtain information. Network node 404 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Network node 404 can receive instructions and other input at a user interface.

Display device 12 is in communication with communication network 402 over communication link 406. Network node 404 is in communication with communication network 402 over communication link 408. Communication links 406, 408 can use various communication media, such as air, space, metal, optical fiber, or some other signal propagation path—including combinations thereof. Communication links 406, 408 can comprise many different signals sharing the same link. Communication links 406, 408 can also include multiple signals operating in a single “airpath” comprising beacon signals, user communications, communication sessions, overhead communications, frequencies, timeslots, transportation ports, logical transportation links, network sockets, packets, or communication directions.

In operation, a user can interact with an initialization indication displayed on the display screen 16 of door display 12 by selecting the initialization indication using an input device such as a finger or stylus. In response, the user can be presented with a plurality of door customization options. For example, glass style, door style, glass and door material, door texture, glass and/or door size, glass shape, glass and door color, glass opacity, door fire rating, door energy rating, and the like. In an exemplary embodiment, the door customization options are displayed on the display screen 16 where an array of small or “thumbnail” images are presented to a user, where the array of images correspond to door characteristics of the same type. However, one of ordinary skill in the art would recognize that the door customization options can be displayed in any format such as list, pull down menu, etc.

In an exemplary embodiment, the door customization options can be stored at network node 404 such that the indication associated with the selection of door customization options is transmitted from display device 12 over communication network 402 to network node 404. Likewise, information associated with the selection can be transmitted from network node 404 to display device 12 over communication network 402. In an alternative embodiment, network node 404 can periodically transmit the door customization information to display device 12, where the door customization information can be then stored in storage node 38 at the display device 12. For example, when a door characteristic is updated, changed, and/or removed, network node 404 can initiate sending the new information associated with the modified door characteristic.

In another exemplary embodiment, after all door customization options are selected at the display device 12, the finalized door customization options can be transmitted to a dealer, distributor, and/or manufacturer through network node 404 over the communication network 402. When the dealer, distributor, and/or manufacturer receive the finalized door customization options, manufacturing of a door matching the finalized door customization options can be initiated.

In another exemplary embodiment, network node 404 can monitor all of the door customization options from the display device 12 to determine the most popular glass selections, door configurations, materials selected, etc. In addition, this information can be used for determining future material needs as well as regional preferences.

In another exemplary embodiment, while not illustrated, a plurality of door displays 12 can be in connection with communication network 402. In this example, the previous interactions from each door display 12 to the network node 404 would be the same. However, network node 404 can further transmit information to one selected door display 12, a group of selected door displays 12 (less than all of the door displays 12 in communication with communication network 402), or all of the door displays 12 in communication with communication network 402. For example, network node 404 can transmit a training video to all of the users or only a selected number of them. Similarly, the network node 402 may transmit information to one or more selected door displays 12 in order to provide promotional information, stylization information, etc. unique to the selected door display(s) 12.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

1. A display device to display door characteristics, comprising:
a door frame;
a first door skin having an opening, wherein the first door skin is coupled to a first face of the door frame;
a display screen provided within the opening of the first door skin; and
a controller node coupled to the display screen, wherein the controller node is configured to
receive an indication of a first input detected at the display screen,
retrieve information associated with a plurality of door characteristics based on the indication of the first input detected at the display screen,
generate an image to display on the display screen based on the plurality of door characteristics,
receive an indication of a second input associated with a selection of one of the plurality of door characteristics displayed on the display screen, and
generate an image associated with the selection of one of the plurality of door characteristics.

2. The display device of claim 1, wherein the controller node retrieves the information associated with the plurality of door characteristics from a storage node located at the display device.

3. The display device of claim 1, wherein the controller node retrieves the information associated with the plurality of door characteristics from a storage node located remotely from the display device.

4. The display device of claim 1, further comprising a network interface, wherein the controller node is configured to retrieve the plurality of door characteristics over a communication network using the network interface.

5. The display device of claim 4, wherein the controller node periodically receives the information associated with the plurality of door characteristics over the network and stores the information associated with the plurality of door characteristics at the storage node at the display device.

6. The display device of claim 1, wherein the information associated with the plurality of door characteristics includes at least one of a glass style, a door style, glass material, door material, door texture, glass size, door size, glass shape, glass color, door color, glass opacity, door fire rating, and door energy rating.

7. The display device of claim 6, wherein the information associated with the glass style includes at least one of a bevel configuration, a bevel arrangement, an art glass shape, different sizes, a glass material, a lite configuration, a side lite configuration, and a transom configuration.

8. The display device of claim 6, wherein the information associated with the door style includes at least one of number of panels, size of panels, panel arrangement, panel configuration, and door installment location.

9. The display device of claim 6, wherein the information associated with the door texture includes at least one of various wood grain textures and the information associated with the door material includes at least one of fiberglass, steel, and wood.

10. The display device of claim 6, wherein the information associated with the glass opacity includes a range of opacity levels.

11. The display device of claim 1, wherein a size of the image associated with the selection of one of the plurality of door characteristics generated is approximately to scale.

12. The display device of claim 1, wherein the controller node is further configured to retrieve a video file from a storage node and display the video file on the display screen.

13. The display device of claim 1, wherein the image associated with the selection of one of the plurality of door characteristics comprises a plurality of door configurations in a side-by-side arrangement.

14. The display device of claim 1, wherein the controller node is further configured to receive an image associated with an intended location where the image associated with the selection of one of the plurality of door characteristics is displayed on the display screen with the image associated with the intended location.

15. A system to display door characteristics on a display device, comprising:
a network node configured to transmit and receive information over a communication network; and
a first display device in communication with the network node, the first display device comprising
a first door frame;
a first door skin having an opening, wherein the first door skin is coupled to a first face of the first door frame;
a first display screen provided within the opening of the first door skin; and
a first controller node coupled to the first display screen, wherein the first controller node is configured to
receive an indication of a first input detected at the first display screen,
retrieve information associated with a plurality of door characteristics based on the indication of the first input detected at the first display screen,
generate an image to display on the first display screen based on the plurality of door characteristics,
receive an indication of a second input associated with a selection of one of the plurality of door characteristics displayed on the first display screen, and
generate an image associated with the selection of one of the plurality of door characteristics.

16. The system of claim 15, further comprising
a second display device comprising
a second door frame;
a second door skin having an opening, wherein the second door skin is coupled to a first face of the second door frame;
a second display screen provided within the opening of the second door skin; and
a second controller node coupled to the second display screen, wherein the second controller node is configured to
receive an indication of a first input detected at the second display screen,
retrieve information associated with a plurality of door characteristics based on the indication of the first input detected at the second display screen,
generate an image to display on the second display screen based on the plurality of door characteristics,
receive an indication of a second input associated with a selection of one of the plurality of door characteristics displayed on the second display screen, and
generate an image associated with the selection of one of the plurality of door characteristics.
wherein the network node is in communication with the second display device over the communication network.

17. The system of claim 16, wherein the network node is configured to periodically transmit updated door characteristic information to the first door display and the second door display.

18. The system of claim 16, wherein the information associated with the plurality of door characteristics is stored at the network node wherein the first controller node and the second controller node retrieve the information associated with the plurality of door characteristic over the communication network.

19. The system of claim 16, wherein the first display device is at a geographic location different from the second display device.

20. A display device to display door characteristics, comprising:
a door frame;
a first door skin having an opening, wherein the first door skin is coupled to a first face of the door frame;
a display screen provided within the opening of the first door skin;
a controller node coupled to the display screen; and
a peripheral device coupled to the controller node,
wherein the controller node is configured to
receive an indication of a first input provided at the peripheral device,
retrieve information associated with a plurality of door characteristics based on the indication of the first input provided at the peripheral device,
generate an image to display on the display screen based on the plurality of door characteristics,
receive an indication of a second input associated with a selection of one of the plurality of door characteristics displayed on the display screen, and
generate an image associated with the selection of one of the plurality of door characteristics.
